(19) United States
(12) Patent Application Publication
(10) Pub. No.: US 2007/0006105 A1
(43) Pub. Date: Jan. 4, 2007

(54) Method and system for synthesis of flip-flops

(75) Inventors: Steven C. Bartling, Plano, TX (US); Marc E. Royer, Garland, TX (US); Charles M. Branch, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/171,160

(22) Filed: Jun. 30, 2005

(51) Int. Cl. G06F 17/50

(52) U.S. Cl. 716/6

(57) ABSTRACT

The method of the present disclosure permits the synthesis of any virtual cell by means of an abstraction, including that of an enable flop, full adder, half adder, or multi-stage multiplexer, based on the ability to extract timing information and add a timing margin to account for clock latency. Specifically, the method of the present disclosure takes advantage of the ability to create synthesis abstractions to build a model of a clock gated enable flop. The synthesis abstraction operates on the assumption that every enable flop has an internally gated clock. The synthesis abstraction may be constructed according to various scripts or algorithms.

### BACKGROUND

1. Technical Field

Various embodiments of the present subject matter relate to integrated circuit design. Various embodiments of the present subject matter relate to a system and method for synthesis of a virtual cell.

2. Background Information

An integrated circuit (“IC”) is a device that incorporates many electronic components (e.g., transistors, resistors, diodes, etc.). These components are often interconnected to form multiple circuit components (e.g., gates, cells, memory units, arithmetic units, controllers, decoders, etc.) on the IC. The electronic and circuit components of IC's are jointly referred to below as “components.” An IC also includes multiple layers of wiring (“wiring layers”) that interconnect its components. For instance, many IC's are currently fabricated with metal or polysilicon wiring layers (collectively referred to below as “metal layers”) that interconnect its components.

Register transfer level description (RTL) is a description of an integrated circuit in terms of data flow between registers, which store information between clock cycles in a circuit. The RTL description specifies what and where this information is stored and how it is passed through the circuit during its operation. RTL is used in the logic design phase of the IC design cycle. Logic simulator tools may verify the correctness of a design by simulating its functionality using its RTL description, among other things. Logic synthesis tools may be used to automatically convert the RTL description of a digital system into a gate level description of the system.

In RTL, it is common to hold a value in a bank of flops in order to meet basic functionality requirements or save power. Holding a value in a bank of flops to prevent unnecessary toggling on logic gates is an effective means of lowering average net switching factors, thus reducing power consumption. Holding a value may be accomplished using an enable flop.

There are two basic ways to implement the enable function using a basic D type flip-flop:
1) Traditional Enable Flops: A 2:1 multiplexer (“MUX”) is placed in front of a standard D type Flip-Flop (“DFF”) and the output of the MUX is connected to the input of the DFF. The flop output is fed back to the input port 0 (I0) on the MUX, and the other input port 1 (I1) on the MUX is connected to the logic cone that supplies the next state of the flop. The select port on the MUX is connected to the enable for the flop.
2) Clock Gating Based Enable Flops: The clock to the flop may be gated using an enable signal. If enable is true, the clock is allowed to propagate to the clock input port on the flop and the flop state is updated with the data value at the input to the flop. If the enable is false, however, the clock is not allowed to propagate to the flop, and the original state of the flop is retained.

The benefits of traditional enable flops, simplicity and compatibility with all tools and place-and-route flows, are outweighed by the disadvantages. The disadvantages include the following: 1) the feedback MUX increases area consumption due to the fact that one 2:1 MUX is required per flop, 2) the feedback MUX increases the setup time required for the data and enable, 3) the clock inputs to the flops are toggled at the full clock frequency, dissipating significant amounts of power, and 4) the feedback MUX adds a gate that must be toggled in order to update the state of the flop, further increasing power consumption.

Clock gating based flops offer some advantages over traditional flops. Higher performance is achieved since the data input port of the flop does not require a MUX in the critical path and the setup time on the enable port of a clock gating cell is typically less than the setup time for the enable port of the traditional enable flop. Using clock gated enable flops results in smaller area since the clock gating cell may be shared among many flops. Lower power consumption is accomplished due to the fact that the feedback MUX is not required, thus saving the power consumed by toggling the feedback MUX at the data switching rate. Additional power is saved since the clock net connected to the flop does not toggle when the clock gating cell is not enabled. Additionally, an enable flop type may be created for each regular flop type without having to actually build and support real cells, reducing the required sequential cell count in standard cell libraries.

The disadvantages of the clock gating style, prior to the present disclosure, were significant. In order to implement enable flops, a clock gate plus a regular DFF required a synopsys power compiler license. Such a license is very expensive, precluding the general implementation and use of the clock gating approach to enable flop implementation. Additionally, clock gating cells adds complexity to a Clock Tree Synthesis (CTS) flow. Extra margin must be applied to clock gating cell enables during pre-CTS ideal clock modes in order to model the effects of clocking latencies on the required arrival times of the enables.

Thus, there is a need for a system and method for synthesizing clock gating based enable flops without the need for an expensive power compiler license and without complicating the Clock Tree Synthesis.

Having recognized the need for the ability to synthesize clock gated enable flops, there is additionally the need for the ability to synthesize other functions. In a design flow in the related art, a half adder, for example, would be implemented in a single cell in order for a synthesis tool to use the base building block to generate complex data paths. The problem with such a synthesis is that the single cell would be sized as a unit, rather than sizing the individual logic elements of the cell being sized separately. If the single cell were synthesized, and then deconstructed into its logic elements, each logic element could be sized independently from the others in order to optimally drive the load. Another example is a multi-stage multiplexer (“MUX”), similarly implemented in the related art as a single cell. Such a single cell multi-stage MUX is also sized as a unit, rather than sizing the individual logic elements of the cell being sized separately.

Thus, there is a need for a system and method for synthesizing various logical functions without the need for an expensive power compiler license.

### SUMMARY

The problems noted above are addressed in large part by a system and method for synthesis of virtual cells, including clock gated enable flops, full adders, half adders and multi-stage multiplexers. Some illustrative embodiments are a computer-readable storage medium containing software that, when executed by a processor, causes the processor to extract timing data relating to a standard cell in a library, add a margin to the timing data, and create an abstraction for the cell, wherein the timing of the abstraction is based on the extracted timing data and the margin, and wherein the abstraction functionally represents a flop in a netlist.

Other illustrative embodiments are a method of synthesis abstraction construction, comprising extracting timing data relating to a standard cell in a library, adding a margin to the timing data, and creating an abstraction for the cell, wherein the timing of the abstraction is based on the extracted timing data and the margin, and wherein the abstraction functionally represents a flop used in a netlist.

Yet further illustrative embodiments are a method comprising replacing an abstraction in a netlist with one or more cells in a library, the cells represented in the netlist by the abstraction, wherein the abstraction has a timing model generated based on timing data for a standard cell and a timing margin.

Other illustrative embodiments are a system comprising a processor for processing instructions, a memory circuit containing the instructions; the memory circuit coupled to the processor, a mass storage device for holding a program operable to transfer the program to the memory circuit, wherein the program on the mass storage device comprises instructions for a method for synthesizing a flop. The method comprises extracting timing data relating to a standard cell in a library, adding a margin to the timing data, and creating an abstraction for the cell, wherein the timing of the abstraction is based on the extracted timing data and the margin, and wherein the abstraction functionally represents a flop in a netlist.

### BRIEF DESCRIPTION OF THE DRAWINGS

For a detailed description of various embodiments of the present disclosure, reference will now be made to the accompanying drawings in which:

FIG. 1A illustrates a computer system which contains a synthesis program incorporating aspects of the present disclosure;

FIG. 1B illustrates is a block diagram of the computer of FIG. 1A;

FIG. 2 illustrates a flow diagram of a technique for enable flop synthesis, in accordance with at least some embodiments;

FIG. 3 illustrates a block diagram of an enable flop implementation built by the synthesis abstraction method, in accordance with embodiments of the present disclosure;

FIG. 4 illustrates a block diagram of a half adder implementation built by the synthesis abstraction method, in accordance with embodiments of the present disclosure;

FIG. 5 illustrates a block diagram of a full adder implementation built by the synthesis abstraction method, in accordance with embodiments of the present disclosure; and

FIG. 6 illustrates a block diagram of a multi-stage multiplexer implementation built by the synthesis abstraction method, in accordance with embodiments of the present disclosure.

### NOTATION AND NOMENCLATURE

Certain terms are used throughout the following discussion and claims to refer to particular system components. This document does not intend to distinguish between components that differ in name but not function.

In the following discussion and in the claims, the terms “including” and “comprising” are used in an open-ended fashion, and thus should be interpreted to mean “including but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Additionally, the term “system” refers broadly to a collection of two or more components and may be used to refer to an overall system as well as a subsystem within the context of a larger system. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION OF THE PREFERRED EMBODIMENTS

The following discussion is directed to various embodiments of the disclosure. Although one or more of these embodiments may be preferred, the embodiments disclosed should not be interpreted, or otherwise used, as limiting the scope of the disclosure, including the claims, unless otherwise specified. The discussion of any embodiment is meant only to be illustrative of that embodiment, and not intended to intimate that the scope of the disclosure, including the claims, is limited to that embodiment.

Customers of IC design enterprises do not wish to use clock gated flops generated by power compilers due to the expense of a license for such a power compiler. The system and method of the present disclosure permit the synthesis of any virtual cell by means of an abstraction, including that of an enable flop of various different types, based on the ability to extract timing information and add a timing margin to account for clock latency. Specifically, the system and method of the present disclosure take advantage of the ability to create synthesis abstractions to build a model of a clock gated enable flop or other type of clock gated flop. The synthesis abstraction operates on the assumption that every flop has an internally gated clock. The synthesis abstraction may be constructed according to various scripts or algorithms, as will be described in greater detail below.

Generally, a special integrated clock-gating (ICG) cell, which combines the various combinational and sequential elements of a clock gate into a single cell, provides a more efficient clock-gating implementation than implementing clock gating structures using basic cell library gates. The ICG cell is implemented to ensure that glitches cannot occur at the gated clock.

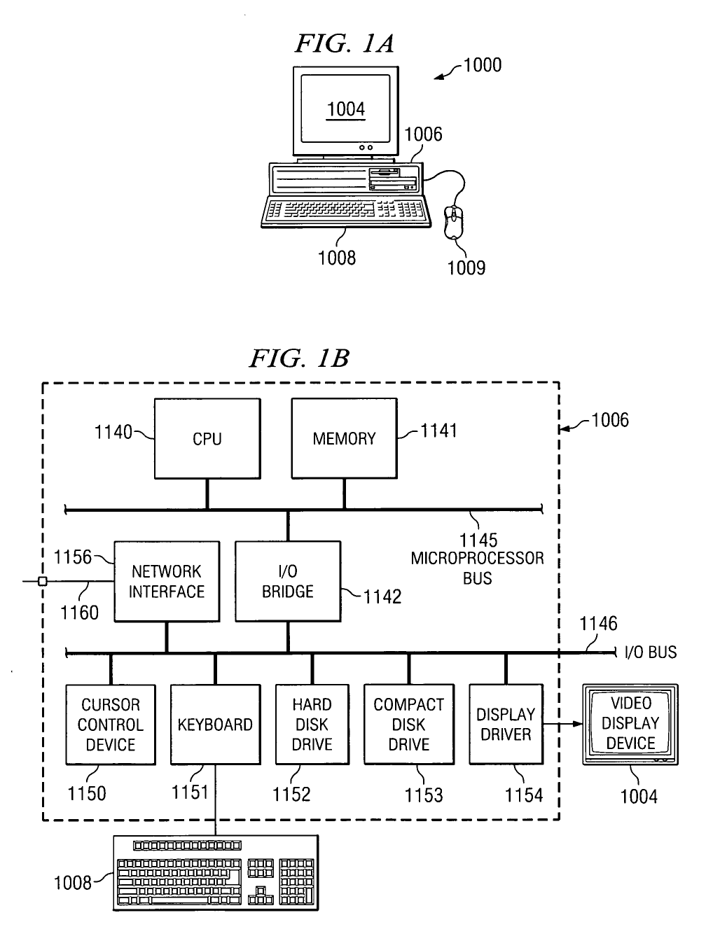

FIG. 1A is an illustration of a computer system 1000 which contains a synthesis program incorporating aspects of the present disclosure, and FIG. 1B3 is a block diagram of the computer of FIG. 1A. A synthesis program that contains steps for synthesizing a clock gated flop according to aspects of the present disclosure, as described in the following paragraphs, is stored on a hard drive 1152. This synthesis program can be introduced into a computer 1000 via a compact disk installed in a compact disk drive 1153, or down loaded via network interact 1156, or by other means, such as a floppy disk or tape, for example. The program is transferred to memory 1141 and instructions which comprise the synthesis program are executed by processor 1140. Library files (.lib) or compiled versions of the .libs (.db) may be stored in memory 1141. A .lib file may include timing information for a typical cell from a cell library, such as setup and hold time information. A “.lib” file is a specific library format for one popular synthesis tool, the Synopsys™ Design Compiler. Although herein “.lib” is the notation used, the system and method described is easily configured to any library data format. A separate synthesis .lib file, as may be generated according to embodiments of the present disclosure, may be generated by the processor 1140 and stored in the memory 1141.

Portions of the integrated circuit design are displayed on monitor 1004. The synthesis program includes a simulator for modeling one or more flops and deconstruction of synthesis abstractions into separate integrated clock-gating cells and regular D type flip flops according to aspects of the present disclosure.

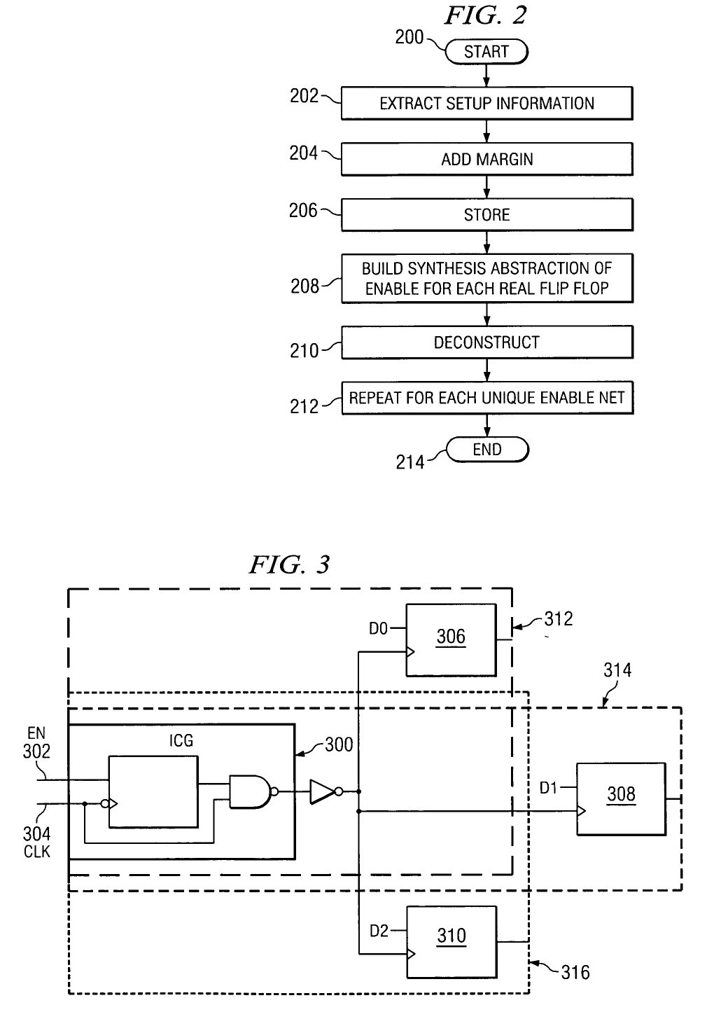

FIG. 2 illustrates a flow diagram of a technique for clock-gated flop synthesis, in accordance with at least some embodiments. The method begins with block 200. In block 202, the synthesis program extracts information for the enable pin of a typical ICG cell from the .lib file. The .lib file is populated with various types of information for every type of flip flop in a cell library. Each flip-flop may additionally be available in differing drive strengths, for which additional timing information is provided by the .lib file. The information extracted in block 202 may include information such as setup and hold timing information. The information for the enable pin may be organized into a data structure, such as a table or vector having multiple entries.

In block 204, the synthesis program adds a fixed amount of additional time margin to each table entry of the setup time. Adding the additional margin accounts for the effect of clock latency on the setup time. Specifically, the clock arrives early to the ICG, placing an additional timing constraint on the enable input. This latency may be accounted for by adding a fixed margin of time into the design of the synthesis abstraction for the flop. The amount of margin is determined by experimentation for each manufacturing process. In an example 90 nm manufacturing process, the fixed amount for the time margin added is 300 picoseconds (ps) for ICG enable flops using an ideal clock based on placement & routing prior to clock tree synthesis. The fixed amount of the time margin is technology dependent.

In block 206, the extracted setup information increased by the margin is stored, creating a new timing table that represents the timing information for the synthesis abstraction of a clock gated flop. The newly created timing table for the enable pin is merged with the timing model for each drive strength of every flop to build a new synthesis .lib file for each real flip-flop that exists in the library (block 208). The enable synthesis .lib file is used to create one or more synthesis abstractions (i.e. a functional representation representative of each clock gated flop) that may later be deconstructed into ICGs and DFFs that actually exist in the cell library. This synthesis abstraction process is also useful for implementation techniques other than a clock-gated enable. For example, in various embodiments, a half adder abstraction can be added to the library and replaced with a XOR2 gate and an AND gate. For example, in various embodiments, a full adder abstraction can be added to the library and replaced with two XOR2 cells, three AND2 cells, and one OR cell. For example, in various embodiments, a multi-stage multiplexer abstraction may be added to the library and replaced with two input MUXes and one output MUX.

Having compiled the synthesis .lib file to generate the synthesis abstraction(s) that represent the flop, deconstruction is performed to decompose the synthesis abstractions into a shared ICG and regular flops that may be found in the library (block 210). Specifically, deconstruction involves identifying all flops in a netlist that connect to the same enable net, as may be determined by examining the connections between the synthesis abstraction clock gated flop(s) and other logic.

Deconstruction in block 210 involves substituting in an ICG for each clock gated net, such that the ICG is shared between all flops that are connected to the same clock gated net, and the output of the ICG cell is connected to the clock port of all of the regular DFF flops that were connected to the particular clock gated net. By sharing an ICG between flops that are connected to the same clock gated net, savings are achieved in power consumption, area, and timing.

In block 212, the process of deconstructing the abstraction representing a flop may be repeated for each unique clock gated net in the design. In a design, numerous different clock gating signals may exist, resulting in various nets interconnected by one of the various clock gating signals. As such, the deconstruction process is performed on each unique clock gated net, so that all of the synthesis abstractions in the design are exchanged for actual ICGs and DFFs. When all of the abstractions have been deconstructed (i.e. replaced by physically realizable flops actually available in the cell library), the process is complete (block 214).

FIG. 3 illustrates a block diagram of an enable flop implementation built by the synthesis abstraction method, in accordance with various embodiments of the present disclosure. The enable flop implementation shown in FIG. 3 may all be represented in one or more functional representation in synthesis abstraction form, while timing information for the abstractions is present in the synthesis .lib file.

As deconstructed, there is an ICG 300 that may be shared by numerous flops. The ICG 300 is fed an enable signal 302 and a clock signal 304. The output of the shared ICG may be fed into one or more regular DFF flops, such as the three shown in the figure, 306, 308, and 310 respectively. Flop 306 has input D0, flop 308 has input D1, and flop 310 has input D2, and each flop is controlled by the enable signal coming from the ICG 300. The abstractions deconstructed may be viewed in FIG. 2 as well. Flop 306 in combination with the ICG may be deconstructed from as an abstraction 312. Likewise, flop 308 in combination with the shared ICG 300 may be deconstructed from an abstraction 314, and flop 310 in combination with the shared ICG 300 may be deconstructed from an abstraction 316. In an embodiment of the present disclosure, the shared ICG 300 may be shared by numerous DFFs requiring the same enable signal.

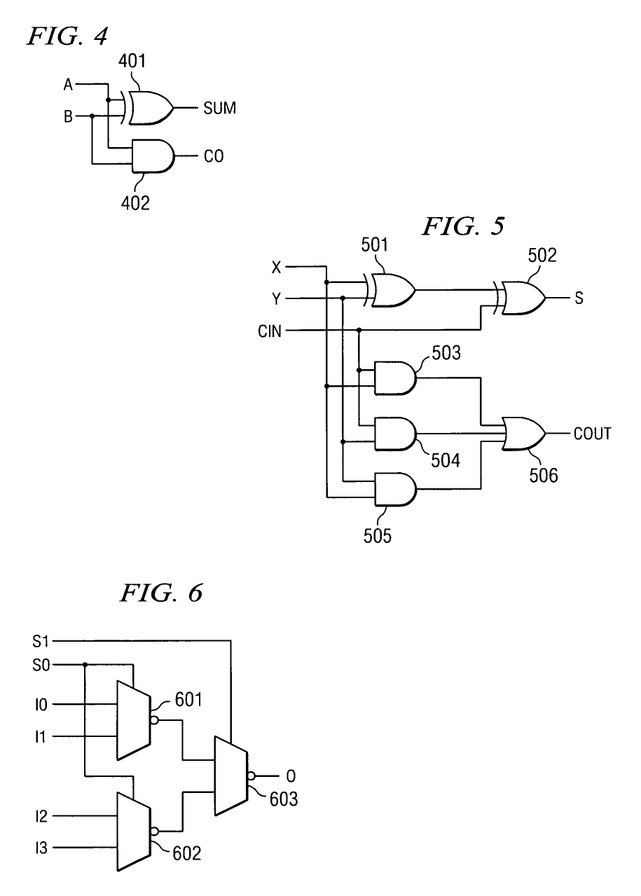

FIG. 4 illustrates a block diagram of a half adder implementation built by the synthesis abstraction method, in accordance with various embodiments of the present disclosure. The half adder implementation shown in FIG. 4 may all be represented in one or more functional representation in synthesis abstraction form, while timing information for the abstractions is present in the synthesis .lib file.

While in a design flow in the related art, a half adder is implemented in a single cell, a half adder may be synthesized according to the synthesis abstraction method in accordance with various embodiments of the present invention. Upon deconstruction, the synthesis abstraction for the half adder is replaced by an XOR cell 401 and an AND cell 402 from the standard cell library. In synthesis, the half adder timing model is modified to account for the extra capacitance and extra delay added by connecting the A and B terminals of the gates. By using the synthesis abstraction in the netlist and later deconstructing it into actual cells from the library, the actual cells may be separately sized to optimally drive the load presented.

FIG. 5 illustrates a block diagram of a full adder implementation built by the synthesis abstraction method, in accordance with various embodiments of the present disclosure. The full adder implementation shown in FIG. 5 may all be represented in one or more functional representation in synthesis abstraction form, while timing information for the abstractions is present in the synthesis .lib file.

While in a design flow in the related art, a full adder is implemented in a single cell, a full adder may be synthesized according to the synthesis abstraction method in accordance with various embodiments of the present invention. Upon deconstruction, the synthesis abstraction for the full adder is replaced by two XOR2 cells 501 and 502, three AND2 cells 503, 504, and 505, and one OR cell 506 from the standard cell library. In synthesis, the full adder timing model is modified to account for the extra capacitance and extra delay added by connecting the terminals of the gates. By using the synthesis abstraction in the netlist and later deconstructing it into actual cells from the library, the actual cells may be separately sized to optimally drive the load presented.

FIG. 6 illustrates a block diagram of a multi-stage multiplexer implementation built by the synthesis abstraction method, in accordance with various embodiments of the present disclosure. The multi-stage multiplexer implementation shown in FIG. 6 may all be represented in one or more functional representation in synthesis abstraction form, while timing information for the abstractions is present in the synthesis .lib file.

While in a design flow in the related art, a multi-stage MUX is implemented in a single cell, a multi-stage MUX may be synthesized according to the synthesis abstraction method in accordance with various embodiments of the present invention. Upon deconstruction, the synthesis abstraction for the multi-stage MUX is replaced by two input MUXes 601 and 602 and one output MUX 603 from the standard cell library. In synthesis, the multi-stage MUX timing model is modified to account for the timing change created by the routing between the two input MUXes 601 and 602 and the output MUX 603, as well as the fact that the SO line connects the two input MUXes 601 and 602. By using the synthesis abstraction in the netlist and later deconstructing it into actual cells from the library, the actual cells may be separately sized to optimally drive the load presented.

The above disclosure is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications. For example, any cell could be synthesized according to embodiments of the present disclosure, and thereafter, each time the abstraction for the virtual cell appears in a netlist, it is deconstructed into independently sizable logical elements.

What is claimed is:

1. A computer-readable storage medium containing software that, when executed by a processor, causes the processor to:
extract timing data relating to a standard cell in a library;
add a margin to the timing data; and
create an abstraction for the cell;
wherein the timing of the abstraction is based on the extracted timing data and the margin; and
wherein the abstraction functionally represents a flop in a netlist.

2. The computer-readable storage medium containing software of claim 1 that, when executed by a processor, causes the processor further to:
presume an internally gated clock.

3. The computer-readable storage medium containing software of claim 1, wherein the timing data comprises setup time.

4. The computer-readable storage medium containing software of claim 1, wherein the timing data comprises hold time.

5. The computer-readable storage medium containing software of claim 1, wherein the margin is a fixed amount.

6. The computer-readable storage medium containing software of claim 1, when executed by a processor, wherein creating an abstraction further causes the processor to:
merge a timing model for the cell in the library with the timing data added to the margin to create a synthesis library file for the cell.

7. A method of synthesis abstraction construction, comprising:
extracting timing data relating to a standard cell in a library;
adding a margin to the timing data; and
creating an abstraction for the cell;
wherein the timing of the abstraction is based on the extracted timing data and the margin; and
wherein the abstraction functionally represents a flop used in a netlist.

8. The method of claim 7, wherein the timing data comprises setup time.

9. The method of claim 7, wherein the timing data comprises hold time.

10. The method of claim 7, further comprising:
presuming an internally gated clock.

11. The method of claim 7, wherein the margin is a fixed amount.

12. The method of claim 7, wherein creating an abstraction for one or more drive strengths further comprises:
merging a timing model for the cell with the timing data added to the margin to create a synthesis library file for the cell.

13. The method of claim 12, wherein creating an abstraction is performed by one or more Perl scripts.

14. A method, comprising:
replacing an abstraction in a netlist with one or more cells in a library, the cells represented in the netlist by the abstraction;
wherein the abstraction has a timing model generated based on timing data for a standard cell and a timing margin.

15. The method of claim 14, wherein at least one abstraction of the netlist is a clock gated enable flop, the abstraction replaced by at least one integrated clock gated cell and at least one flop.

16. The method of claim 15, wherein a clock gated signal is shared by one or more abstractions of a clock gated enable flop.

17. The method of claim 14, wherein the abstraction is a clock gated half adder, the abstraction replaced by at least one XOR2 cell and at least one AND2 cell.

18. The method of claim 14, wherein the abstraction is a clock gated full adder, the abstraction replaced by at least two XOR2 cells, at least three AND2 cells, and at least one OR cell.

19. The method of claim 14, wherein the abstraction is a multi-stage multiplexer, the abstraction replaced by at least two input multiplexer cells and at least one output multiplexer cell.

20. The method of claim 14, wherein the abstraction is a virtual cell without a physically realizable cell in a library correlating to the abstraction.

21. The method of claim 14, wherein the at least one integrated clock gated cell and at least one flop are physically realizable cells available in a standard cell library.

22. The method of claim 14, further comprising:
linking abstractions having a clock gated signal in common by replacing at least a portion of each abstraction with a shared integrated clock gated cell.

23. The method of claim 14, wherein the scanning and replacing is performed by one or more TCL scripts.

24. A system, comprising:
a processor for processing instructions;
a memory circuit containing the instructions; the memory circuit coupled to the processor;
a mass storage device for holding a program operable to transfer the program to the memory circuit;
wherein the program on the mass storage device comprises instructions for a method for synthesizing a flop, the method comprising:
extracting timing data relating to a standard cell in a library;
adding a margin to the timing data; and
creating an abstraction for the cell;
wherein the timing of the abstraction is based on the extracted timing data and the margin; and
wherein the abstraction functionally represents a flop in a netlist.

25. The system of claim 24, wherein the timing data comprises setup time.

26. The system of claim 24, wherein the timing data comprises hold time.

27. The system of claim 24, wherein the program further comprises:
presuming an internally gated clock.

28. The system of claim 24, wherein the margin is a fixed amount.

29. The system of claim 24, wherein creating an abstraction further comprises:
merging a timing model for the cell with the timing data added to the margin to create a synthesis library file for the cell.

30. The system of claim 29, wherein creating an abstraction is performed by one or more scripts.
